(19) United States
(12) Patent Application Publication
(10) Pub. No.: US 2020/0059309 A1
(43) Pub. Date: Feb. 20, 2020

(54) SYSTEM FOR EVENT-BASED TARGETED ADVERTISING

(71) Applicant: DIGICAP CO., LTD., Seoul (KR)

(72) Inventor: Sungheun Oh, Seoul (KR)

(73) Assignee: DIGICAP CO., LTD., Seoul (KR)

(21) Appl. No.: 16/537,634

(22) Filed: Aug. 12, 2019

(30) Foreign Application Priority Data
Aug. 14, 2018 (KR) 10-2018-0095023

(51) Int. Cl. H04H 60/37; H04H 60/19; H04N 21/236; H04N 21/643

(52) U.S. Cl. CPC H04H 60/375; H04N 21/64322; H04N 21/23614; H04H 60/19

(57) ABSTRACT

Provided is a system for targeted advertising including a broadcast transmission system, an advertisement service system, and a broadcast receiving device. The broadcast transmission system acquires information indicating whether target advertisement is performable by replacing the existing broadcasting advertisement from the advertisement service system and transmits broadcast signaling including a target advertisement chance information event through a broadcast network. The broadcast receiving device, upon receiving the target advertisement chance information event, acquires metadata regarding a target advertisement and target advertisement content from the advertisement service system and reproduces the target advertisement content by replacing the existing advertisement in a targeted advertisement section.

### CROSS-REFERENCE TO RELATED APPLICATION(S)

This application claims priority from Korean Patent Application No. 10-2018-0095023, filed on Aug. 14, 2018, in the Korean Intellectual Property Office, the disclosure of which is incorporated herein by reference in its entirety.

### BACKGROUND

### 1. Field

The following description relates to a technology for providing a targeted advertisement service, and more specifically, to a system for providing a viewer-customer targeted advertisement replacing existing broadcasting advertisement in a real-time television (TV) broadcasting.

### 2. Description of Related Art

In the existing real-time television (TV) broadcasting services, broadcasting advertisements are provided as one-sided advertisements by advertisers who purchase media advertisement sections irrespective of the types of broadcast receivers, viewer characteristics, viewing environments, and the like. On the other hand, online advertisements provided on the Internet or mobile applications are provided as appropriate target advertisements to appropriate devices, to appropriate viewers, and at appropriate times using an algorithm of analyzing big data and recommending advertisement through collection of usage behaviors of viewers, thereby maximizing the efficiency in advertisement exposure, securing brand awareness, and maximizing conversion rates of purchase from the advertisers' perspective. As for TV broadcasting services, a pre-roll advertisement exposed during a time of content being loaded is targeted and provided in a clip video, a video-on-demand (VOD) service, and the like provided as additional services, or targeted advertisement services are provided through enhanced/independent interactive advertisement.

Recently, technologies for providing targeted advertisements in real time TV broadcasting have been developed. The next generation terrestrial broadcasting standard adopting dynamic adaptive streaming over HTTP (DASH)-based media transfer protocol as a transmission method provides a targeted advertisement mechanism in which a receiver replaces the existing advertisement content with targeted advertisement content at a certain point of time using xlink technology included in media presentation description (MPD) and reproduce the targeted advertisement content. However, such a method is only usable in a media transfer protocol using DASH and is not usable in other types of media transfer protocols. In addition, the Xlink technology operates to directly associate with substitute targeted advertisement content, thus having difficulty in linking with other functions required for targeted advertisements (e.g., targeted advertisement metadata, additional information linking uniform resource locator (URL) provision, tracking function in playback of a targeted advertisement, etc.).

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a method for a targeted advertisement service in which a broadcast receiving device configured to reproduce a targeted advertisement by receiving a broadcast signal transmitted through a TV broadcast network replaces a basic broadcasting advertisement with a viewer-customized targeted advertisement such that the viewer-customized targeted advertisement is reproduced at a corresponding advertisement time.

The following description relates to a method for a targeted advertisement service in which, in addition to simply replacing the existing advertisement, various additional functions, such as advertisement tracking and the like, are serviced together through targeted advertisement serving metadata without targeted advertisement content directly linked to a targeted advertisement section.

The following description relates to a method for a targeted advertisement service capable of operating irrespective of a media transfer protocol.

In one general aspect, a system for targeted advertising includes a broadcast transmission system, an advertisement service system, and an advertisement service system. The broadcast transmission system is configured to generate broadcast signaling including a targeted advertisement chance information event and a broadcast content stream and transmit the generated broadcast signaling and the broadcast content stream through a broadcast network. The advertisement service system is configured to provide the broadcast transmission system with targeted advertisement chance information and provide the broadcast receiving device with targeted advertisement serving metadata and advertisement content for a targeted advertisement. The broadcast receiving device is configured to receive a broadcast signal including the broadcast signaling and the broadcast content stream through the broadcast network to reproduce content such that targeted advertisement content received as a result of requesting the advertisement service system is replaced to be reproduced in an advertisement section.

Other features and aspects will be apparent from the following detailed description, drawings, and claims.

### BRIEF DESCRIPTION OF THE DRAWINGS

FIG. 1 is a schematic view illustrating a system for targeted advertising according to an exemplary embodiment of the present invention.

FIG. 2 is a schematic block diagram illustrating a broadcast transmission system of a system for targeted advertising according to another exemplary embodiment of the present invention.

FIG. 3 is a schematic block diagram illustrating an advertisement service system of a system for targeted advertising according to another exemplary embodiment of the present invention.

FIG. 4 is a schematic block diagram illustrating a broadcast receiving device of a system for targeted advertising according to another exemplary embodiment of the present invention.

FIG. 5 is a block diagram illustrating a system for targeted advertising according to another exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The foregoing and additional aspects of the present invention will be embodied through the following exemplary embodiments. It should be understood that elements in each exemplary embodiment may allow various combinations unless otherwise specified or contradicted within the exemplary embodiment. Each block in block diagrams may represent a physical component or a logical expression of partial functions of a single physical component or of functions across a plurality of physical components. A block or part thereof may be an entity representing a set of program instructions. Blocks may, entirely or in part, be implemented as hardware, software, or combination thereof.

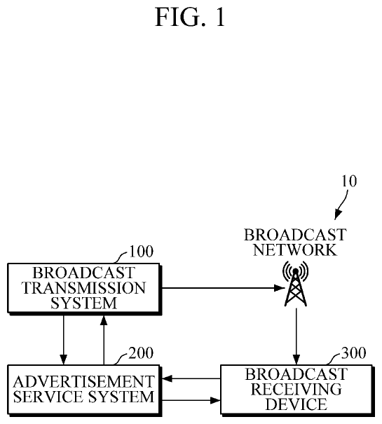

FIG. 1 is a schematic view illustrating a system 10 for targeted advertising according to an exemplary embodiment of the present invention. Referring to FIG. 1, the system 10 for targeted advertising according to the exemplary embodiment of the present invention includes a broadcast transmission system 100, an advertisement service system 200, and a broadcast receiving device 300. The system 10 for targeted advertising according to the exemplary embodiment of the present invention allows the broadcast receiving device 300, which is capable of reproducing a targeted advertisement, to receive and reproduce a real time TV broadcast such that a viewer-customized targeted advertisement is reproduced by replacing a basic broad advertisement transmitted through a TV broadcast network.

The system 10 for targeted advertising may provide a targeted advertisement service for a next generation broadcasting service including an advanced television systems committee (ATSC) 3.0 UHD terrestrial TV broadcasting service and the like. The ATSC 3.0 standard defines two methods for transmitting broadcasting services. The first method is based on MPEG Media Transport (MMT) and transmits a media processing unit (MPU) using an MMT Protocol (MMTP). The second method is based on a dynamic adaptive streaming over HTTP (DASH)-Industry Forum (IF) profile of MPEG DASH and transmits a DASH segment using a real-time object delivery over unidirectional transport (ROUTE) protocol. Data processed according to the MMTP or ROUTE protocol may be processed into Internet Protocol (IP) packets through User Datagram Protocol (UDP)/IP layers.

The broadcast transmission system 100 according to the exemplary embodiment of the present invention generates broadcast signaling including a targeted advertisement chance information event and a broadcast content stream and transmits the broadcast signaling and the broadcast content stream through a broadcast network. The broadcast transmission system 100 is a server or a set of servers configured to generate a broadcast content stream and broadcast signaling for providing a broadcasting service and transmit the broadcast content stream and the broadcast signaling through a broadcast network.

The broadcast signaling is provided to transmit broadcasting service information including a service name, a service identifier, a genre, a channel number, and the like, and information regarding a media transfer protocol type (e.g., ROUTE, MMT, MPEG-2 Transport Stream (TS), Real-time Transport Protocol (RTP), and the like), and the broadcast signaling is information that needs to be received first by the broadcast receiving device 300, such as a TV receiver and the like, for broadcast watching. The broadcast signaling may be transported regardless of the media transfer protocol or may be transported through the media transfer protocol depending on the time point or information in which the broadcast signaling is transported. For example, in the case of a broadcasting service of ATSC 3.0 standard, the broadcast signaling in ATSC 3.0 is divided into low level signaling (LLS) and service level signaling (SLS). LLS is multicast with a fixed IP regardless of the media transfer protocol. Service list table (SLT), which is one type of LLS, transports information indicating broadcast channels included in each broadcasting service, media transfer protocol (ROUTE or MMT) used by each broadcast channel, and information such as an IP address, a port number, and the like of the broadcast channel through which SLS is transported. An example of the transportation through the media transfer protocol may include SLS in a ROUTE method, and SLS includes user service bundle description (USBD), which is a type of XML, configured to transport general information, such as service ID of a corresponding broadcast channel, service-based transport session instance description (S-TSID), which is a type of XML, configured to transport network information regarding an IP session in which a video stream and audio stream of a corresponding broadcast channel are transported, and media presentation description (MPD), which is a type of XML, in which codec information for video and audio contents, bit ratio, language, file type, and other information are described and transported.

The targeted advertisement chance information event includes targeted advertisement section information including time information of a targeted advertisement section and access position information of a server for providing targeted advertisement serving metadata. The targeted advertisement chance information event is transported through the broadcast signaling, and in the case of ROUTE, may be defined as a lower <Event> of <EventStream> of MPD and is transported. As another example, in the case of MMT, the targeted advertisement chance information event may be defined as a lower <Event> of <EventStream> of application event information (AEI) signaling and is transported.

The targeted advertisement chance information event is included in the broadcast signaling in response to an existence of an advertisement section that has a chance to be replaced with a targeted advertisement. The targeted advertisement section information essentially includes time information of a targeted advertisement section and optionally includes an event stream identifier (e.g., scheme identifier and value) and an event identifier for uniquely identifying the event. The time information in the targeted advertisement section information may be expressed in the form of <targeted advertisement section start time, targeted advertisement section length> or <targeted advertisement section start time, targeted advertisement section end time>.

The targeted advertisement serving metadata includes information about a targeted advertisement to be reproduced by the broadcast receiving device 300 in a targeted advertisement section by replacing an existing advertisement. According to aspects of the present invention, the targeted advertisement serving metadata may be expressed by an interactive advertising bureau (IAB) video ad serving template (VAST). The targeted advertisement serving metadata is generated using targeted advertisement chance information, which is transported from the advertisement service system 200 after determining an existence of an advertisement section that is replaceable with a targeted advertisement in response to a request of the broadcast transmission system 100 to check for an existence of an advertisement section in which a targeted advertisement is performable. The targeted advertisement serving metadata essentially includes access position information (e.g., URL) in which substitute advertisement content is stored and optionally includes advertiser information, an advertisement title, an advertisement identifier, an advertisement length, an event to be tracked in playback of an advertisement (e.g., an advertisement reproduction start, an advertisement reproduction end, and the like), and access position information (e.g., URL) of a server to which a tracking result is reported.

The broadcast content stream is a content stream compressed-using video/audio codecs. In the ATSC 3.0 standard, the transport container format of media content is based on an ISO base media file format (ISOBMFF).

The advertisement service system 200 manages advertisement section information and provides targeted advertisement chance information to provide a targeted advertisement service. In addition, the advertisement service system 200 manages targeted advertisement serving metadata and provides advertisement content determined to be used for a replacement.

The advertisement service system 200 provides the targeted advertisement chance information while interworking with the broadcast transmission system 100. The advertisement service system 200 determines an advertisement section in which targeted advertisement is performable using the targeted advertisement chance information managed by the advertisement service system 200 according to a request of the broadcast transmission system 100 to check a targeted advertisement chance and transport targeted advertisement chance information in response to the request. The targeted advertisement chance information includes targeted advertisement section information including time information of a targeted advertisement section, access position information of a server for providing targeted advertisement serving metadata, and the like.

In addition, the advertisement service system 200 provides the broadcast receiving device 300 with the targeted advertisement serving metadata for the targeted advertisement and the replaced targeted advertisement content. In this case, the advertisement service system 200, upon receiving a request of the broadcast receiving device 300 for the targeted advertisement serving metadata, determines a viewer-customized advertisement using an identification value (e.g., a device ID) for identifying the broadcast receiving device 300 and an identification value (e.g., an IP address of the broadcast receiving device 300) for identifying an area in which the broadcast receiving device 300 is located, the identification value being included in the request.

The broadcast receiving device 300 receives the broadcast content stream and the final broadcast signaling received through the broadcast network, provides viewers with a broadcasting service, and reproduces the targeted advertisement determined in association with the targeted advertisement service according to the targeted advertisement section. That is, the broadcast receiving device 300 receives broadcast signals including the broadcast signaling and the broadcast content stream and reproduces the broadcast content stream. In addition, the broadcast receiving device 300 acquires access position information of the server for providing targeted advertisement serving metadata from the targeted advertisement chance information event included in the broadcast signaling, requests targeted advertisement serving metadata from the advertisement service system 200, and receives the targeted advertisement serving metadata. The broadcast receiving device 300 downloads or streams targeted advertisement content using access position information, in which substitute advertisement content is stored, included in the received targeted advertisement serving metadata and reproduces the targeted advertisement content in the advertisement section by replacing the existing advertisement. The broadcast receiving device 300 continues reproducing the existing broadcast content stream after the targeted advertisement end time.

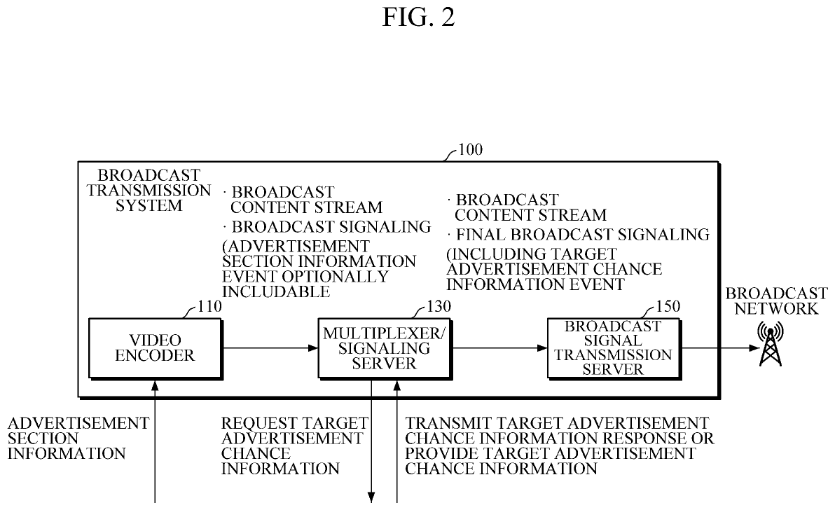

FIG. 2 is a schematic block diagram illustrating a broadcast transmission system of a system for targeted advertising according to another exemplary embodiment of the present invention. Referring to FIG. 2, a broadcast transmission system 100 according to the exemplary embodiment of the present invention includes a video encoder 110, a multiplexer/signaling server 130, and a broadcast signal transmission server 150.

The video encoder 110 may generate the broadcast content stream compressed using the video/audio codecs and the broadcast signaling and output the broadcast content stream and the broadcast signaling. According to aspects of the invention, the video encoder 110 may generate an ISOBMFF file-based broadcast content stream that is optimized for real time streaming. The video encoder 110 may generate media data as an MPU file when the media transfer protocol is MMT and may generate media data in the form of a DASH segment when the media transfer protocol is ROUTE.

The multiplexer/signaling server 130 serves to transport the broadcast content stream and the final broadcast signaling, which will be transmitted through the broadcast network, to the broadcast signal transmission server 150. The multiplexer/signaling server 130 may request the advertisement service system 200 to check whether the broadcast content stream includes an advertisement section and the advertisement section has a chance to be replaced with a targeted advertisement section. In this case, the advertisement service system 200, in response to determining an existence of a targeted advertisement chance, may transmit a targeted advertisement chance information response including targeted advertisement section information and access position information of a targeted advertisement serving metadata providing server 230. The multiplexer/signaling server 130, upon receiving the targeted advertisement chance information response, may add a targeted advertisement chance information event in the final broadcast signaling and transport the final broadcast signaling to the broadcast signal transmission server 150.

According to aspects of the invention, the multiplexer/signaling server 130 may be implemented separately as a multiplexer and a signaling server.

The broadcast signal transmission server 150 may transmit the broadcast content stream and the broadcast signaling transported from the multiplexer/signaling server 130 through the broadcast network.

According to another exemplary embodiment of the present invention, the advertisement service system 200 may transport advertisement section information in a broadcast schedule to the broadcast transmission system 100. In this case, the video encoder 110 may generate an advertisement section information event including time information of an advertisement section from the received advertisement section information and add the advertisement section information event in the broadcast signaling.

The advertisement section information event may essentially include time information of an advertisement section and optionally include an event stream identifier (e.g., scheme Identifier and value) and an event identifier for uniquely identifying the advertisement section information event. The time information of the advertisement section may be expressed in the form of <advertisement section start time, advertisement section length> or <advertisement section start time, advertisement section end time>. According to aspects of the present invention, the advertisement section information may be expressed in a cue event format based on the society of cable and telecommunications engineers (SCTE)-35 standard. The cue event includes time information of an advertisement section and may optionally include an event stream identifier and an event identifier for uniquely identifying a corresponding event.

The advertisement section information included in the advertisement section information event is not information indicating an advertisement section that is replaceable with a targeted advertisement but is information regarding a broadcasting advertisement section according to a broadcast schedule.

In response to an advertisement section information not being received from the advertisement service system 200, the video encoder 110 may generate broadcast signaling that does not include an advertisement section information event.

When the video encoder 110 generates and transports the broadcast signaling is including the advertisement section information event using the advertisement section information transported from the advertisement service system 200, the multiplexer/signaling server 130 may request targeted advertisement chance information with respect to the advertisement section of the advertisement section information event from the advertisement service system 200. The advertisement service system 200 determines whether the advertisement section is an advertisement section having a chance to be replaced with a targeted advertisement, and in response to the advertisement section being determined to have a chance for a targeted advertisement, transmits a targeted advertisement chance information response including targeted advertisement section information and access position information of the targeted advertisement serving metadata providing server 230. The multiplexer/signaling server 130, upon receiving the targeted advertisement chance information response, may replace the advertisement section information event with the targeted advertisement chance information event and transmit the broadcast signaling to the broadcast signal transmission server 150.

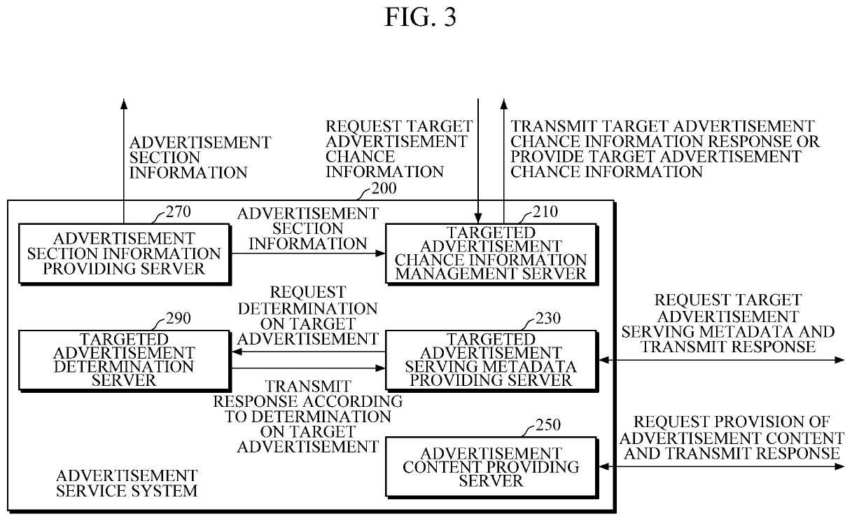

FIG. 3 is a schematic block diagram illustrating an advertisement service system of a system for targeted advertising according to another exemplary embodiment of the present invention. The advertisement service system 200 according to the exemplary embodiment of the present invention includes a targeted advertisement chance information management server 210, a targeted advertisement serving metadata providing server 230, and an advertisement content providing server 250.

The targeted advertisement chance information management server 210 may manage information about an advertisement section of an advertisement that is replaceable with a targeted advertisement among advertisements in a broadcast schedule, determine whether an advertisement section included in a request of the broadcast transmission system 100 is a section having a chance for a targeted advertisement, and transmit targeted advertisement chance information including targeted advertisement section information and access position information of the targeted advertisement serving metadata providing server 230. That is, the targeted advertisement chance information management server 210 has information about an advertisement section of an advertisement that is replaceable with a targeted advertisement among advertisements in the broadcast schedule and also has access position information of the targeted advertisement serving metadata providing server 230 that is needed by the broadcast receiving device 300, which will be described below, when requesting targeted advertisement serving metadata with respect to the replaceable advertisement section. The targeted advertisement chance information management server 210, upon receiving a request for targeted advertisement chance information made by the broadcast transmission system 100, checks whether an advertisement section included in the request is replaceable with a targeted advertisement. The targeted advertisement chance information management server 210, in response to determining the advertisement section to have a chance to be replaced with a targeted advertisement, may transmit a targeted advertisement chance information response including targeted advertisement section information and access position information of the targeted advertisement serving metadata providing server 230 to the broadcast transmission system 100. The targeted advertisement chance information management server 210, in response to determining the advertisement section not to have a chance to be replaced with a targeted advertisement, may transmit a response instructing that the advertisement section information event should be deleted or ignored.

The targeted advertisement serving metadata providing server 230 may generate target advertisement serving metadata when the broadcast receiving device 300 requests target advertisement serving metadata and transmit a response.

The target advertisement serving metadata includes information about a target advertisement that is replaceable by the broadcast receiving device 300 in a replaceable advertisement section. That is, the target advertisement serving metadata includes access position information of a server for providing substitute advertisement content. A target advertisement is determined according to a request of the broadcast receiving device 300 managing the target advertisement serving metadata. In this case, the request of the broadcast receiving device 300 may include a device identifier for identifying the broadcast receiving device 300 or an IP address of the broadcast receiving device 300 for inferring an area in which the broadcast receiving device 300 is located. The targeted advertisement serving metadata providing server 230 may determine a target advertisement using identification information for identifying the broadcast receiving device 300 or an area of the broadcast receiving device 300. The targeted advertisement serving metadata providing server 230, after determining the target advertisement, provides the broadcast receiving device 300 with target advertisement serving metadata.

The targeted advertisement serving metadata essentially includes access position information in which substitute advertisement content is stored and optionally includes at least one of advertiser information, an advertisement title, an advertisement identifier, an advertisement length, information about an advertisement tracking event to be tracked in playback of an advertisement, and access position information of a server to which an advertisement tracking event result is reported. According to aspects of the invention, the targeted advertisement serving metadata may be expressed as an IAB VAST.

The advertisement content providing server 250 is a server that is accessible by the broadcast receiving device 300 with the access position information included in the targeted advertisement serving metadata, in which substitute advertisement content is stored, and the advertisement content providing server 250 may provide targeted advertisement content according to a request of the broadcast receiving device 300 for substitute advertisement content. The method of providing substitute advertisement content may be implemented through downloading, streaming, and other various methods.

As shown in FIG. 3, the advertisement service system 200 according to the exemplary embodiment of the present invention may include the targeted advertisement chance information management server 210, the targeted advertisement serving metadata providing server 230, and the advertisement content providing server 250 and may further include an advertisement section information providing server 270.

The advertisement section information providing server 270 manages time information of a section of an advertisement included in a broadcast schedule (e.g., a program advertisement, a station break (SB), a time checking advertising, etc.) and provides the broadcast transmission system 100 or the targeted advertisement chance information management server 210 with advertisement section information. The advertisement section information is transported at a time point that is sufficiently earlier (e.g., by several tens of seconds) than a start time of a corresponding broadcast section.

The targeted advertisement chance information management server 210, upon receiving advertisement section information from the advertisement section information providing server 270, may automatically determine whether the corresponding advertisement section has a chance for targeted advertisement and transport targeted advertisement chance information including targeted advertisement section information and access position information of the targeted advertisement serving metadata providing server 230 to the broadcast transmission system 100.

As shown in FIG. 3, the advertisement service system 200 according to the exemplary embodiment of the present invention may include the targeted advertisement chance information management server 210, the targeted advertisement serving metadata providing server 230, and the advertisement content providing server 250 and may further include a targeted advertisement determination server 290.

The targeted advertisement determination server 290 may determine a targeted advertisement according to a request of the broadcast receiving device 300 transported from the targeted advertisement serving metadata providing server 230 and transmit a response regarding the determination to the targeted advertisement serving metadata providing server 230. The targeted advertisement serving metadata providing server 230, upon receiving the response, may provide targeted advertisement serving metadata according to the determination of the targeted advertisement determination server 290.

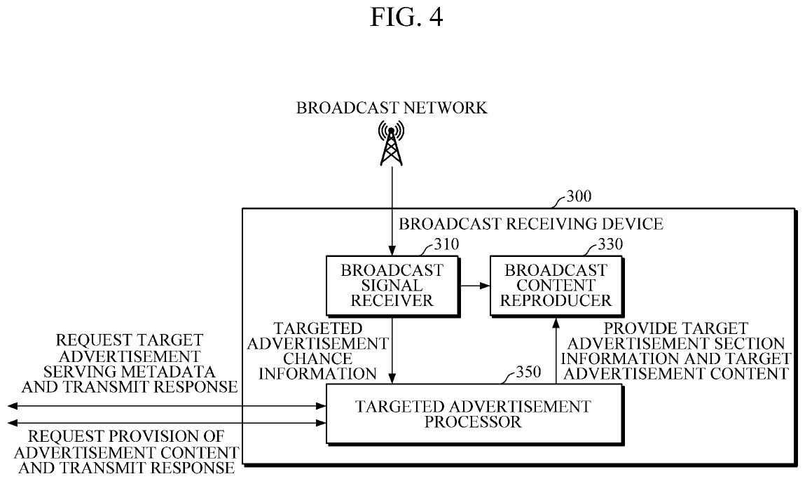

FIG. 4 is a schematic block diagram illustrating a broadcast receiving device of a system for targeted advertising according to another exemplary embodiment of the present invention. Referring to FIG. 4, the broadcast receiving device 300 according to the exemplary embodiment of the present invention may include a broadcast signal receiver 310, a broadcast content reproducer 330, and a targeted advertisement processor 350.

The broadcast signal receiver 310 may receive the broadcast content stream using the received broadcast signaling and transport the broadcast content stream to the broadcast content reproducer 330 to reproduce broadcast content. In addition, when the received broadcast signaling includes a targeted advertisement chance information event, the broadcast signal receiver 310 may transport targeted advertisement chance information included in the targeted advertisement chance information event to the targeted advertisement processor 350.

The targeted advertisement processor 350 may acquire targeted advertisement serving metadata using access position information of the targeted advertisement serving metadata providing server 230 included in the targeted advertisement chance information transported from the broadcast signal receiver 310. In this case, a request for the targeted advertisement serving metadata may optionally include a device identifier of the broadcast receiving device 300 or a receiver identifier for inferring an area in which the broadcast receiving device 300 is located, for example, an IP address of the broadcast receiving device 300.

The broadcast content reproducer 330 may reproduce the broadcast content stream transported from the broadcast signal receiver 310.

The targeted advertisement processor 350 according to the exemplary embodiment of the present invention may request substitute targeted advertisement content using the access position information of the advertisement content providing server 250 included in the targeted advertisement serving metadata acquired from the targeted advertisement serving metadata providing server 230 as a response to the request for the targeted advertisement serving metadata and acquires the requested targeted advertisement content. In this case, the broadcast content reproducer 330 may stop a broadcast content stream, having been reproduced, at a targeted advertisement start time and reproduce the targeted advertisement content provided by the targeted advertisement processor 350. In this case, the broadcast content reproducer 330 may continue reproducing the previous broadcast content stream after a targeted advertisement end time.

When the targeted advertisement serving metadata acquired from the targeted advertisement serving metadata providing server 230 includes advertisement tracking event information and access position information of a tracking report server to which an advertisement tracking event result is reported, the targeted advertisement processor 350 according to the exemplary embodiment of the present invention may track advertisement reproduction and report a result of tracking the advertisement reproduction to the tracking report server.

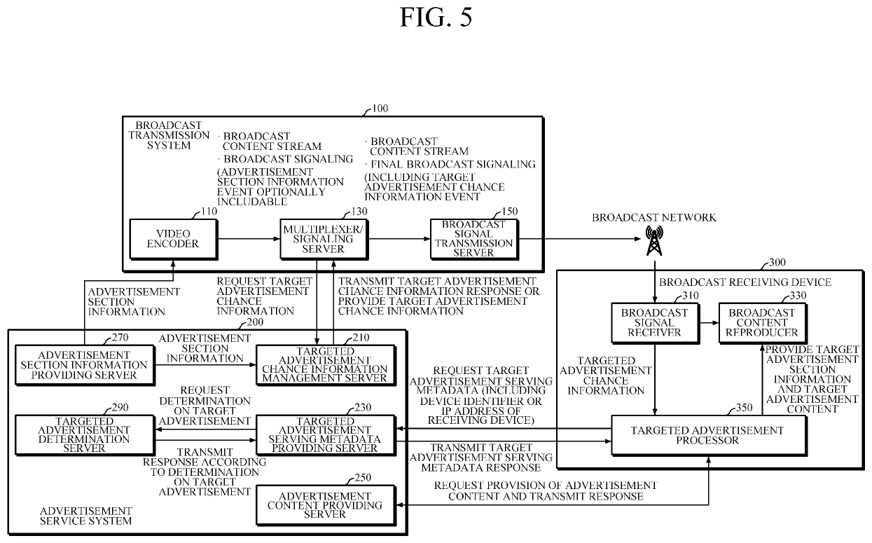

FIG. 5 is a block diagram illustrating a system for targeted advertising according to another exemplary embodiment of the present invention.

Referring to FIG. 5, the system 10 for targeted advertising may include a broadcast transmission system 100, an advertisement service system 200, and a broadcast receiving device 300.

The broadcast transmission system 100 may include a video encoder 110, a multiplexer/signaling server 130, and a broadcast signal transmission server 150.

The video encoder 110 may generate the broadcast content stream compressed using the video/audio codecs and the broadcast signaling and output the broadcast content stream and the broadcast signaling. According to aspects of the invention, the video encoder 110 may generate an ISOBMFF file-based broadcast content stream that is optimized for real time streaming. The video encoder 110 may generate media data as an MPU file when the media transfer protocol is MMT and may generate media data in the form of a DASH segment when the media transfer protocol is ROUTE. In this case, the video encoder 110 may add an advertisement section information event in the broadcast signaling to be output upon receiving advertisement section information included in a broadcast schedule from an advertisement section information providing server 270. In this case, in response to advertisement section information not being received, the video encoder 110 may output broadcast signaling that does not include an advertisement section information event.

The advertisement section information event essentially includes time information of an advertisement section and optionally includes an event stream identifier (e.g., a scheme identifier and value) and an event identifier for uniquely identifying the advertisement section information event. The time information of the advertisement section may be expressed in the form of <advertisement section start time, advertisement section length> or <advertisement section start time, advertisement section end time>. According to aspects of the present invention, the advertisement section information may be expressed in a cue event format based on SCTE 35 standard. The cue event includes time information of an advertisement section and may optionally include an event stream identifier and an event identifier for uniquely identifying a corresponding event.

The advertisement section information included in the advertisement section information event is not information indicating an advertisement section that is replaceable with a targeted advertisement but is information regarding a broadcasting advertisement section according to a broadcast schedule.

The multiplexer/signaling server 130 serves to transport the broadcast content stream and the final broadcast signaling, which will be transmitted through the broadcast network, to the broadcast signal transmission server 150. When the video encoder 110 generates broadcast signaling including an advertisement section information event using advertisement section information transported from the advertisement section information providing server 270 of the advertisement service system 200 and transports the generated broadcasting signaling to the broadcast signal transmission server 150, the multiplexer/signaling server 130 may request targeted advertisement chance information with respect to the advertisement section of the advertisement section information event from a targeted advertisement chance information management server 210 of the advertisement service system 200. The targeted advertisement chance information management server 210 of the advertisement service system 200 determines whether the advertisement section has a chance to be replaced with a targeted advertisement, and in response to the advertisement section being determined to have a chance to be replaced with a targeted advertisement, transmits a targeted advertisement chance information response including targeted advertisement section information and access position information of a targeted advertisement serving metadata providing server 230. The multiplexer/signaling server 130, upon receiving the targeted advertisement chance information response, may replace the advertisement section information event with the targeted advertisement chance information event, and transmit the broadcast signaling to the broadcast signal transmission server 150. According to aspects of the invention, the multiplexer/signaling server 130 may be implemented separately as a multiplexer and a signaling server.

The broadcast signal transmission server 150 may transmit the broadcast content stream and the broadcast signaling transported from the multiplexer/signaling server 130 through the broadcast network.

The advertisement service system 200 may include the targeted advertisement chance information management server 210, the targeted advertisement serving metadata providing server 230, and an advertisement content providing server 250.

The targeted advertisement chance information management server 210 may manage information about an advertisement section of an advertisement that is replaceable with a targeted advertisement among advertisements in an advertisement schedule, determine whether an advertisement section included in a request of the multiplexer/signaling server 130 of the broadcast transmission system 100 is a section having a chance for a targeted advertisement, and transport targeted advertisement chance information including targeted advertisement section information and access position information of the targeted advertisement serving metadata providing server 230. That is, the targeted advertisement chance information management server 210 has information about an advertisement section of an advertisement that is replaceable with a targeted advertisement among advertisements in the broadcast schedule and also has access position information of the targeted advertisement serving metadata providing server 230 that is needed by a targeted advertisement processor 350 of the broadcast receiving device 300 when requesting targeted advertisement serving metadata with respect to the advertisement section that is replaceable with a targeted advertisement. The targeted advertisement chance information management server 210, upon receiving a request for targeted advertisement chance information made by the multiplexer/signaling server 130 of the broadcast transmission system 100, checks whether an advertisement section included in the request is replaceable with a targeted advertisement. The targeted advertisement chance information management server 210, in respond to determining the advertisement section to have a chance to be replaced with a targeted advertisement, may transport a targeted advertisement chance information response including targeted advertisement section information and access position information of the targeted advertisement serving metadata providing server 230 to the multiplexer/signaling server 130 of the broadcast transmission system 100. The targeted advertisement chance information management server 210, in response to determining the advertisement section to not have a chance to be replaced with a targeted advertisement, may transmit a response instructing that the advertisement section information event should be deleted or ignored. Additionally, the targeted advertisement chance information management server 210 may receive advertisement section information included in the broadcast schedule from the advertisement section information providing server 270 and may automatically determine whether the corresponding advertisement section has a chance to be replaced with a targeted advertisement. In response to determining the corresponding advertisement section to have a chance to be replaced with a targeted advertisement, the targeted advertisement chance information management server 210 may provide the multiplexer/signaling server 130 of the broadcast transmission system 100 with targeted advertisement chance information including targeted advertisement section information and access position information of the targeted advertisement serving metadata providing server 230 before a start point of the corresponding targeted advertisement section.

The targeted advertisement serving metadata providing server 230 may generate targeted advertisement serving metadata when the targeted advertisement processor 350 of the broadcast receiving device 300 requests targeted advertisement serving metadata and transmit a response.

The targeted advertisement serving metadata includes information about a targeted advertisement that is replaceable by the broadcast receiving device 300 in a replaceable advertisement section. That is, the targeted advertisement serving metadata includes access position information of a server for providing substitute advertisement content. The targeted advertisement serving metadata providing server 230 that manages targeted advertisement serving metadata determines a targeted advertisement according to a request of the targeted advertisement processor 350 of the broadcast receiving device 300. In this case, the request of the targeted advertisement processor 350 of the broadcast receiving device 300 may include a device ID for identifying the broadcast receiving device 300 or an IP address of the broadcast receiving device 300 for inferring an area in which the broadcast receiving device 300 is located. The targeted advertisement serving metadata providing server 230 may determine the targeted advertisement using identification information for identifying the broadcast receiving device 300 or the area of the broadcast receiving device 300. After determining the targeted advertisement, the targeted advertisement serving metadata providing server 230 provides the targeted advertisement processor 350 of the broadcast receiving device 300 with the targeted advertisement serving metadata.

The targeted advertisement serving metadata essentially includes access position information in which substitute advertisement content is stored and optionally includes at least one of advertiser information, an advertisement title, an advertisement identifier, an advertisement length, information about an advertisement tracking event to be tracked in playback of an advertisement, and access position information of a server to which an advertisement tracking event result is reported. According to aspects of the invention, the targeted advertisement serving metadata may be expressed in IAB VAST.

The advertisement content providing server 250 is a server that is accessible by the targeted advertisement processor 350 of the broadcast receiving device 300 with the access position information included in the targeted advertisement serving metadata, in which substitute advertisement content is stored, and the advertisement content providing server 250 may provide targeted advertisement content according to a request of the targeted advertisement processor 350 of the broadcast receiving device 300 for substitute advertisement content. The method of providing substitute advertisement content may be implemented through downloading, streaming, and other various methods.

The advertisement section information providing server 270 manages time information of a section of an advertisement included in a broadcast schedule (e.g., a program advertisement, an SB, a time checking advertising, etc.) and provides the video encoder 110 of the broadcast transmission system 100 or the targeted advertisement chance information management server 210 with advertisement section information. The advertisement section information is transported at a time point that is sufficiently earlier (e.g., by several tens of seconds) than a start time of a corresponding broadcast section.

The broadcast receiving device 300 may include a broadcast signal receiver 310, a broadcast content reproducer 330, and a targeted advertisement processor 350.

The broadcast signal receiver 310 may receive the broadcast content stream using the received broadcast signaling and transport the broadcast content stream to the broadcast content reproducer 330 to reproduce broadcast content. In addition, since the received broadcast signaling includes the targeted advertisement chance information event, the broadcast signal receiver 310 may transport the targeted advertisement chance information included in the targeted advertisement chance information event to the targeted advertisement processor 350.

The targeted advertisement processor 350 may acquire targeted advertisement serving metadata using access position information of the targeted advertisement serving metadata providing server 230 included in the targeted advertisement chance information transported from the broadcast signal receiver 310. In this case, a request for the targeted advertisement serving metadata may optionally include a device identifier of the broadcast receiving device 300 or a receiver identifier for inferring an area in which the broadcast receiving device 300 is located, for example, an IP address of the broadcast receiving device 300.

The broadcast content reproducer 330 may reproduce the broadcast content stream transported by the broadcast signal receiver 310.

The targeted advertisement processor 350 may request substitute targeted advertisement content using the access position information of the advertisement content providing server 250 included in the targeted advertisement serving metadata acquired from the targeted advertisement serving metadata providing server 230 as a response to the request for the targeted advertisement serving metadata and acquire the requested targeted advertisement content. In this case, the broadcast content reproducer 330 may stop a broadcast content stream, having been reproduced, at a targeted advertisement start time and reproduce the targeted advertisement content provided by the targeted advertisement processor 350. In this case, the broadcast content reproducer 330 may continue reproducing the previous broadcast content stream after a targeted advertisement end time.

In addition, when the targeted advertisement serving metadata acquired from the targeted advertisement serving metadata providing server 230 includes advertisement tracking event information and access position information of a tracking report server to which an advertisement tracking event result is reported, the targeted advertisement processor 350 may track advertisement reproduction and report a result of tracking the advertisement reproduction to the tracking report server.

As shown in FIG. 5, the advertisement service system 200 according to the exemplary embodiment of the present invention may further include a targeted advertisement determination server 290.

The targeted advertisement determination server 290 may determine a targeted advertisement according to a request of the broadcast receiving device 300 transported from the targeted advertisement serving metadata providing server 230 and transmit a response regarding the determination to the targeted advertisement serving metadata providing server 230. The targeted advertisement serving metadata providing server 230, upon receiving the response, may provide targeted advertisement serving metadata according to the determination of the targeted advertisement determination server 290.

As is apparent from the above, the broadcast receiving device configured to reproduce a targeted advertisement can replace a basic broadcasting advertisement with a viewer-customized targeted advertisement such that the viewer-customized targeted advertisement is reproduced at a corresponding advertisement time.

In addition to simply replacing the existing advertisement, various additional functions, such as advertisement tracking and the like, can be serviced together using targeted advertisement serving metadata with respect to an advertisement section in which a targeted advertisement is performable.

The targeted advertisement service can be provided irrespective of a media transfer protocol.

Although the present invention has been described by the exemplary embodiments with reference to the accompanying drawings, it will be apparent to those skilled in the art that various modifications can be made to the above-described exemplary embodiments of the present invention without departing from the spirit or scope of the invention. Thus, it is intended that the present invention covers all such modifications provided they fall within the scope of the appended claims and their equivalents.

What is claimed is:

1. A system for event-based targeted advertising, the system comprising:
a broadcast transmission system configured to generate broadcast signaling including a targeted advertisement chance information event and a broadcast content stream and transmit the generated broadcast signaling and the broadcast content stream through a broadcast network;
an advertisement service system configured to provide the broadcast transmission system with targeted advertisement chance information and provide targeted advertisement serving metadata and advertisement content for a targeted advertisement; and
a broadcast receiving device configured to receive a broadcast signal including the broadcast signaling and the broadcast content stream through the broadcast network to reproduce content such that targeted advertisement content received as a result of requesting the advertisement service system is replaced to be reproduced in an advertisement section,
wherein the targeted advertisement chance information event includes targeted advertisement section information including time information of a targeted advertisement section and access position information of a targeted advertisement serving metadata providing server for providing the targeted advertisement serving metadata, and
the targeted advertisement serving metadata includes access position information of an advertisement content providing server in which substitute targeted advertisement content is stored.

2. The system of claim 1, wherein the broadcast transmission system includes:
a video encoder configured to generate the broadcast content stream compressed using a video codec and an audio codec and the broadcast signaling;
a multiplexer/signaling server configured to add the targeted advertisement chance information event in the broadcast signaling and transport the broadcast signaling; and
a broadcast signal transmission server configured to transmit the broadcast content stream and the broadcast signaling transported from the multiplexer/signaling server through the broadcast network.

3. The system of claim 2, wherein the advertisement service system transports advertisement section information included in a broadcast schedule to the broadcast transmission system, and
the video encoder generates an advertisement section information event including time information of an advertisement section from the received advertisement section information and adds the generated advertisement section information event in the broadcast signaling.

4. The system of claim 3, wherein the multiplexer/signaling server, upon receiving targeted advertisement chance information with respect to the advertisement section of the advertisement section information event as a result of requesting the advertisement service system, replaces the advertisement section information event with a targeted advertisement chance information event to be transported to the broadcast transmission server, and
the advertisement service system determines whether the advertisement section in the request received from the multiplexer/signaling server has a chance to be replaced with a targeted advertisement and transmits a response.

5. The system of claim 1, wherein the advertisement service system includes:
the targeted advertisement serving metadata providing server configured to manage targeted advertisement serving metadata including access position information of a server for providing substitute advertisement content, determine a targeted advertisement according to a request of the broadcast receiving device, and provide the targeted advertisement serving metadata;
a targeted advertisement chance information management server configured to manage information about an advertisement section of an advertisement that is replaceable with a targeted advertisement among advertisements in a broadcast schedule, determine whether an advertisement section included in a request of the broadcast transmission system has a targeted advertisement chance, and transport targeted advertisement chance information including targeted advertisement section information and the access position information of the targeted advertisement serving metadata providing server; and
the advertisement content providing server configured to provide targeted advertisement content according to the request of the broadcast receiving device for substitute advertisement content.

6. The system of claim 5, wherein the targeted advertisement serving metadata further includes at least one of advertiser information, an announcement title, an advertisement identifier, an advertisement length, information about an advertisement tracking event to be tracked in playback of an advertisement, and access position information of a server to which an advertisement tracking event result is reported.

7. The system of claim 5, wherein the advertisement service system further includes an advertisement section information providing server configured to manage time information of an advertisement section included in a broadcast schedule and provide the broadcast transmission system or the targeted advertisement chance information management server with the advertisement section information.

8. The system of claim 7, wherein the targeted advertisement chance information management server, upon receiving the advertisement section information from the advertisement section information providing server, determines whether the advertisement section is a section having a targeted advertisement chance and transports targeted advertisement chance information including targeted advertisement section information and the access position information of the targeted advertisement serving metadata providing server.

9. The system of claim 5, wherein the advertisement service system further includes a targeted advertisement determination server configured to determine a targeted advertisement according to the request of the broadcast receiving device, which is transported from the targeted advertisement serving metadata providing server, and
the targeted advertisement serving metadata providing server provides the targeted advertisement serving metadata according to the determination of the targeted advertisement determination server.

10. The system of claim 6, wherein the broadcast receiving device includes:
a broadcast signal receiver configured to receive the broadcast content stream and the broadcast signaling;
a targeted advertisement processor configured to request the targeted advertisement serving metadata using the access position information of the targeted advertisement serving metadata providing server included in the targeted advertisement chance information transported from the broadcast signal receiver; and
is a broadcast content reproducer configured to reproduce the broadcast content stream transported from the broadcast signal receiver.

11. The system of claim 10, wherein the request for the targeted advertisement serving metadata made by the targeted advertisement processor includes a device ID or an Internet Protocol (IP) address of the broadcast receiving device.

12. The system of claim 10, wherein the targeted advertisement processor requests substitute targeted advertisement content using the access position information of the advertisement content providing server included in the targeted advertisement serving metadata acquired from the targeted advertisement serving metadata providing server and acquires the requested targeted advertisement content, and
the broadcast content reproducer stops a broadcast content stream, having been reproduced, at a targeted advertisement start time and reproduces the targeted advertisement content provided by the targeted advertisement processor.

13. The system of claim 10, wherein the targeted advertisement processor, when the targeted advertisement serving metadata acquired from the targeted advertisement serving metadata providing server includes advertisement tracking event information and access position information of a tracking report server to which an advertisement tracking event result is reported, tracks advertisement reproduction and reports a result of tracking the advertisement reproduction to the tracking report server.

14. A broadcast transmission system of a system for targeted advertising service including the broadcast transmission system, an advertisement service system, and a broadcast receiving device, the broadcast transmission system comprising:
a video encoder configured to generate a broadcast content stream compressed using a video codec and an audio codec and broadcast signaling;
a multiplexer/signaling server configured to add a targeted advertisement chance information event in the broadcast signaling and transport the broadcast signaling; and
a broadcast signal transmission server configured to transmit the broadcast content stream and the broadcast signaling transported from the multiplexer/signaling server through a broadcast network,
wherein the targeted advertisement chance information event includes targeted advertisement section information including time information of a targeted advertisement section and access position information of a targeted advertisement serving metadata providing server for providing targeted advertisement serving metadata.

15. The broadcast transmission system of claim 14, wherein the video encoder generates an advertisement section information event including time information of an advertisement section from advertisement section information transported from the advertisement service system and adds the generated advertisement section information event in the broadcast signaling.

16. The broadcast transmission system of claim 15, wherein the multiplexer/signaling server, upon receiving targeted advertisement chance information with respect to the advertisement section of the advertisement section information event as a result of requesting the advertisement service system, replaces the advertisement section information event with a targeted advertisement chance information event to be transported to the broadcast transmission server.

17. An advertisement service system of a system for targeted advertising including a broadcast transmission system, an advertisement service system, and a broadcast receiving device, the advertisement service system comprising:
a targeted advertisement serving metadata providing server configured to manage targeted advertisement serving metadata including access position information of a server for providing substitute advertisement content and, according to a request of the broadcast receiving device, provide targeted advertisement serving metadata including the access position information of the advertisement content providing server in which substitute target advertisement content is stored;
a targeted advertisement chance information management server configured to manage information about an advertisement section of an advertisement that is replaceable with a targeted advertisement among advertisements in a broadcast schedule and transport targeted advertisement chance information including targeted advertisement section information and the access position information of the targeted advertisement serving metadata providing server; and
an advertisement content providing server configured to provide targeted advertisement content according to a request of the broadcast receiving device for substitute advertisement content.

18. The advertisement service system of claim 17, wherein the targeted advertisement serving metadata further includes at least one of advertiser information, an announcement title, an advertisement identifier, an advertisement length, information about an advertisement tracking event to be tracked in playback of an advertisement, and access position information of a server to which an advertisement tracking event result is reported.

19. The advertisement service system of claim 17, wherein the advertisement service system further includes an advertisement section information providing server configured to manage time information of an advertisement section included in a broadcast schedule and provide the broadcast transmission system or the targeted advertisement chance information management server with advertisement section information.

20. The advertisement service system of claim 19, wherein the targeted advertisement chance information management server, upon receiving the advertisement section information from the advertisement section information providing server, determines whether the advertisement section is a section having a targeted advertisement chance and transports targeted advertisement chance information including targeted advertisement section information and the access position information of the targeted advertisement serving metadata providing server.

21. The advertisement service system of claim 17, wherein the advertisement service system further includes a targeted advertisement determination server configured to determine a targeted advertisement according to a request of the broadcast receiving device, which is transported from the targeted advertisement serving metadata providing server, and
the targeted advertisement serving metadata providing server provides the targeted advertisement serving metadata according to the determination of the targeted advertisement determination server.

22. A broadcast receiving device of a system for targeted advertising including a broadcast transmission system, an advertisement service system, and a broadcast receiving device, the broadcast receiving device comprising:
a broadcast signal receiver configured to receive a broadcast content stream and broadcast signaling;
a targeted advertisement processor configured to request targeted advertisement serving metadata using access position information of a server for providing targeted advertisement serving metadata included in targeted advertisement chance information transported from the broadcast signal receiver; and
a broadcast content reproducer configured to reproduce the broadcast content stream transported from the broadcast signal receiver,
wherein a targeted advertisement chance information event includes targeted advertisement section information including time information of a targeted advertisement section and the access position information of the server for providing targeted advertisement serving metadata, and
the targeted advertisement serving metadata includes access position information of an advertisement content providing server in which substitute targeted advertisement content is stored.

23. The broadcast receiving device of claim 22, wherein the request for the targeted advertisement serving metadata made by the targeted advertisement processor includes a device ID or an Internet Protocol (IP) address of the broadcast receiving device.

24. The broadcast receiving device of claim 22, wherein the targeted advertisement processor requests substitute targeted advertisement content using the access position information of the advertisement content providing server included in the targeted advertisement serving metadata acquired from the targeted advertisement serving metadata providing server and acquires the requested targeted advertisement content, and
the broadcast content reproducer stops a broadcast content stream, having been reproduced, at a targeted advertisement start time and reproduces the targeted advertisement content provided by the targeted advertisement processor.

25. The broadcast receiving device of claim 22, wherein the targeted advertisement processor, when the targeted advertisement serving metadata acquired from the targeted advertisement serving metadata providing server includes advertisement tracking event information and access position information of a tracking report server to which an advertisement tracking event result is reported, tracks advertisement reproduction and reports a result of tracking the advertisement reproduction to the tracking report server, and
the targeted advertisement serving metadata further includes at least one of advertiser information, an announcement title, an advertisement identifier, an advertisement length, information about an advertisement tracking event to be tracked in playback of an advertisement, and access position information of a server to which the advertisement tracking event result is reported.
